(19) United States
(12) Patent Application Publication
(10) Pub. No.: US 2011/0095060 A1
(43) Pub. Date: Apr. 28, 2011

(54) DEVICE FOR LATERALLY POSITIONING AN OBJECT IN A CONTAINER

(75) Inventors: Jochen WERNER, Wiesbaden (DE); Hassan MIR, Mainz (DE); Alexander LEICHT, Renningen (DE)

(73) Assignee: GM GLOBAL TECHNOLOGY OPERATIONS, INC., Detroit, MI (US)

(21) Appl. No.: 12/822,007

(22) Filed: Jun. 23, 2010

(30) Foreign Application Priority Data
Jun. 26, 2009 (DE) 102009030576.9

(51) Int. Cl. B60R 7/00

(52) U.S. Cl. 224/539

(57) ABSTRACT

A device is provided for laterally positioning at least one object, in particular a beverage cup, a beverage can or a bottle, in relation to a receptacle arranged in a motor vehicle that partially accommodates the object. In such a device, the latter has a frame section with positioning elements mounted therein, and the frame section exhibits grooved areas at least on facing sides to accommodate the positioning elements in the frame section, as well as positioning elements that extend into the opening formed by the frame section.

### CROSS-REFERENCE TO RELATED APPLICATION

This application claims priority to German Patent Application No. 102009030576.9, filed Jun. 26, 2009, which is incorporated herein by reference in its entirety.

### TECHNICAL FIELD

The invention relates to a device for laterally positioning at least one object, in particular a beverage cup, a beverage can or a bottle in relation to a receptacle arranged in a motor vehicle that partially accommodates the object.

### BACKGROUND

Motor vehicles make use of drink container holders, also called cup holders. They are most often provided in the area of a recess in a central console of the motor vehicle, or a recess in the instrument panel of the motor vehicle. The central console or instrument panel accommodates the receptacle in a formed retainer space, which is in turn provided for holding the at least one object. In particular, this object is a beverage cup, a beverage can or a bottle. In order to prevent such an object filled with a beverage from tilting while driving, the device is provided for laterally positioning the object. The container is very suitable for accommodating several receptacles.

Known from prior art are varying configurations of devices for laterally positioning at least one object in a receptacle situated in a motor vehicle. One device of the kind mentioned at the outset is known from DE 101 34 027 A1. The receptacle has an oval storage compartment. The device for laterally positioning the object is designed as a rotatable divider, which has a cylindrical wall that extends over a portion of the circumference. The latter can be moved into the storage compartment by turning the divider in such away as to divide a roughly cylindrical adjustment area for adjusting the object, for example a beverage can. This device is structurally complicated, and requires a relatively large amount of space within the receptacle in both its functional and non-functional position, in particular from the standpoint of storing the device in the receptacle.

DE 203 08 296 U1 describes a storage compartment with a shell-shaped depression and a cover. The storage compartment has retaining elements that comprise a single piece with the cover, along with additional retaining elements arranged on the inside of the shell-shaped depression. The retaining elements are used to hold objects, such as cups, beverage cans, bottles or the like.

Known from DE 197 24 599 A1 is a device for laterally positioning at least one object in a receptacle, which has spring elements that act on objects placed in the receptacle. Additional devices for laterally positioning at least one object relative to a receptacle are described in DE 10 2005 019 485 A1, DE 10 2005 057 330 A1, DE 20 2005 010 253 U1, DE 20 2006 013 840 U1 and U.S. Pat. No. 6,915,997 B2.

At least one object of the present invention is to further develop a device of the kind mentioned at the outset in such a way as to give it an especially simple structural design, while in the process ensuring a precise positioning of the at least one object. In addition, other objects, desirable features, and characteristics will become apparent from the subsequent summary and detailed description, and the appended claims, taken in conjunction with the accompanying drawings and this background.

### SUMMARY

At least the one object, and potentially other objects, desirable features and characteristics, are achieved by virtue of the fact that the device has a frame section with positioning elements mounted therein, wherein the frame section exhibits grooved areas at least on facing sides to accommodate the positioning elements in the frame section, as well as the positioning elements that extend into the opening formed by the frame section

Depending on the design of the positioning elements, the grooved areas formed in the frame section are exceedingly well suited for merely accommodating them, or even guiding them as well. The grooved areas form legs, in particular parallel legs, in the frame section, between that the positioning elements are situated. The legs are exceedingly well suited for laterally holding or guiding the positioning elements. The depth of the groove must be selected in particular in such a way that, given positioning elements rigidly connected with the frame section, the latter are sufficiently fixed in the frame section, or in the case of positioning elements that can move relative to the frame sections, the bearing areas for the positioning elements are also reliably accommodated in the frame section.

As a consequence, it is regarded as especially advantageous for the grooved areas to have a U-shaped cross section, with parallel legs and a web that connects the latter and comprises the floor of the groove. In relation to a horizontally parked motor vehicle, in particular a passenger car, the grooved areas are horizontally oriented, so that the legs are horizontally situated.

For example, the respective positioning element is rigidly connected with the frame section. In this case, the positioning element is in particular designed to be flexible, so that when an object is placed in the receptacle, it can yield when the object contacts the positioning element in either the direction of the groove base, meaning the web connecting the legs, or that the area of the flexible positioning element projecting out of the groove can be more or less downwardly bent during exposure to the object. If the object is again removed from the receptacle, the flexible characteristics of the positioning element cause it to spring back into its initial position.

The respective positioning element can indeed be designed and/or accommodated in such a way that it can move in the direction of the groove base and oppositely in the frame section. For example, this movable accommodation is achieved based on the elasticity of the positioning element, or because an indeed rigidly designed positioning element is mounted so that it can move in the groove of the frame section. In the latter case, it is provided in particular that the respective positioning element can be moved in the direction of the groove base against the force exerted by a spring. This mode of action can be realized while maintaining the simplest possible structural design for the positioning element. For example, it is designed as a simple molding with a U-shaped cross section, wherein the legs of the positioning element are inserted into the groove of the frame section, and guided in the area of the legs of the frame section. A spring means, for example a helical compression spring or some other elastic spring member, is active between the web of the frame section and the web of the positioning element.

Another alternative design provides that the respective positioning element have a bearing part accommodated in the frame section and a positioning element pivoted therein, which extends into the opening formed by the frame section, and can pivot up or down. In this configuration, it is provided in particular that the positioning element can be pivoted up or down out of a horizontal initial position against the force exerted by a spring, and can be moved back into the initial position from the pivoted position in response to the spring force.

One especially structurally simple design for the respective positioning element is obtained by designing the latter as a strip. The strip is inserted in the allocated groove of the frame section, and the portion extending beyond the groove extends into the opening formed by the frame section.

One especially functional configuration of the device is obtained by making the frame section rectangular, and arranging the positioning elements in the area of the two longitudinal sides of the rectangle. In particular, two positioning elements are arranged in the area of each longitudinal side of the rectangle. It is best for the side of the respective positioning element facing the opening to have at least one abutting surface area that curves away from the opening. In particular when two adjacent positioning elements interact, this yields curved abutting surface areas of the positioning elements that are best suited for establishing a flat contact with the object placed in the receptacle or the objects placed in the receptacle.

A special embodiment of the invention provides that the frame section be detachably connectable with the lateral walls of the receptacle. If the frame section, and hence the device is detached from the receptacle, the receptacle provides a large storage space for objects that is not reduced by the device in terms of the cross section of the upper opening. In this case, the receptacle is exceedingly well suited for accommodating relatively large objects, for example a book. By contrast, if objects that hold liquids are to be laterally positioned, the device is connected with the receptacle by joining, e.g., clipping, the frame section with the receptacle.

In particular, the receptacle is designed as a separate structural unit with a floor and lateral walls, wherein the receptacle can be placed in a storage space of a console, in particular a central console of the motor vehicle, or a storage space in an instrument panel of the motor vehicle.

### BRIEF DESCRIPTION OF THE DRAWINGS

The present invention will hereinafter be described in conjunction with the following drawing figures, wherein like numerals denote like elements, and:

FIG. 1 in a spatial view is a section of a central console of a passenger car with receptacle incorporated therein, which is provided with the device for laterally positioning at least one object accommodated by the receptacle;

FIG. 2 is a vertical section cut perpendicular to the receptacle and device, with the device removed from the receptacle;

FIG. 3 in a spatial view is the device for laterally positioning several objects as used in the embodiment according to FIG. 1 and FIG. 2; and

FIG. 4 to FIG. 9 are sectional views depicting various configurations for mounting positioning elements in the frame section of the device.

### DETAILED DESCRIPTION

The following detailed description is merely exemplary in nature and is not intended to limit application and uses. Furthermore, there is no intention to be bound by any theory presented in the preceding background or summary or the following detailed description.

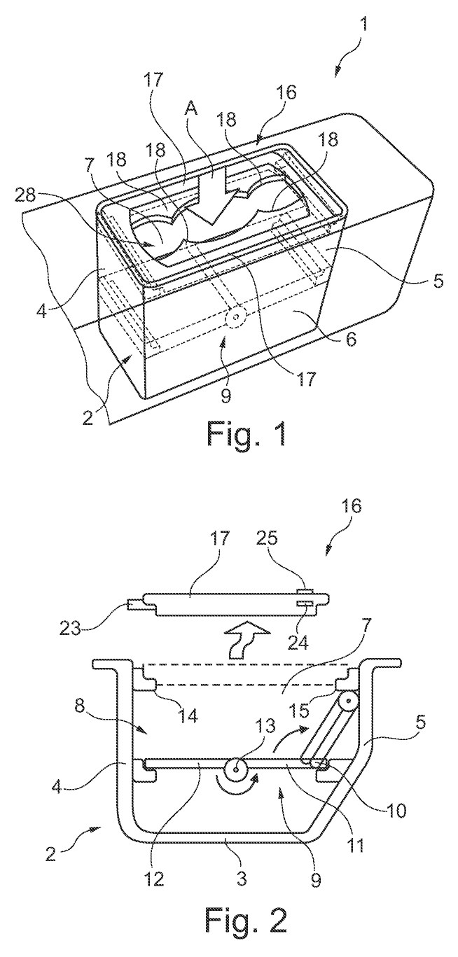

As evident from the depiction on FIG. 1 and FIG. 2, the receptacle 2 has a floor 3 arranged horizontally in relation to the horizontal arrangement of the passenger car, as well as walls joined with the floor 3, specifically a front wall 4, a rear wall 5, and two mutually parallel lateral walls 6 and 7 relative to the orientation of the passenger car. This forms a storage space 8 open to the top in the receptacle 2. The storage space can be divided horizontally by means of a folding intermediate floor 9, which is shown in its deployed functional position on FIG. 1, and in both its functional position and its retracted position on FIG. 2. The intermediate floor 9 is mounted in the rear wall 5 so that it can pivot around an axis 10 in the area of one end, and the two intermediate floor parts 11 and 12 are hinged with an axis 13. The receptacle 2 provides a storage space 8 for large objects when the intermediate floor 19 is retracted, while there is room for relatively smaller objects in the storage area between the floor 3 and the intermediate floor 9 as well as above the intermediate floor 9 when the intermediate floor 9 is deployed in a position where both intermediate floor parts hit a stop.

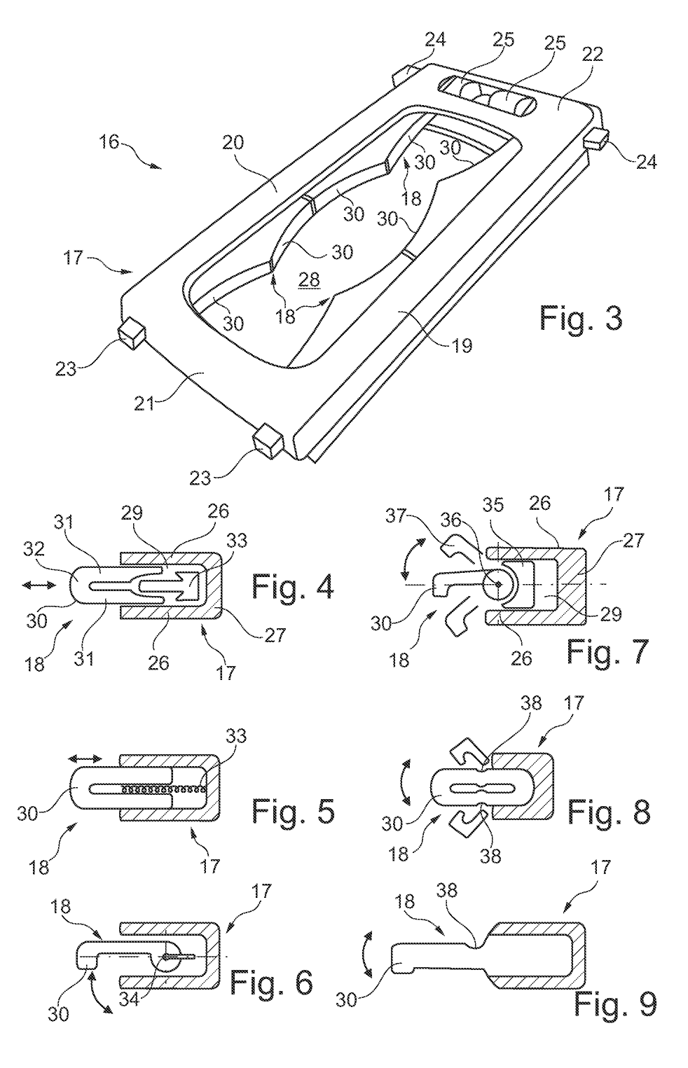

Bearing strips 14 and 15 are connected with the front wall 4 and rear wall 5 in the area of their upper ends, and serve to accommodate a device 16 for laterally positioning at least one object, wherein the latter in particular can be a beverage cup, a beverage can or bottle. As especially evident from the depiction on FIG. 3, this device 16 has a frame section 17, and positioning elements 18 mounted therein. The frame section 17 is rectangular, with two longitudinally running sections 19 and 20, as well as two transversely running sections 21 and 22. The section 21 is provided with two spaced apart, longitudinally running fixed projections 23. They are used for insertion into two recesses in the front wall 4 of the receptacle 2 (not shown). In the area of the other end of the frame section 17, meaning section 22, the frame section 17 incorporates two retractable and extendible projections 24 for insertion in recesses in the lateral walls 6 and 7 (also not shown). The two projections 24 can be retracted by the restoring force exerted by a spring incorporated in the frame section 17. The two projections 24 are adjusted by sliders, which each form a structural unit with the projection 24. Therefore, the device 16 is secured to the receptacle 2 by inserting the projections 23 into the recesses in the receptacle 2 in the area of the front wall 4, and then pivoting the frame section 17 down into the horizontal position with the projections 24 having moved toward each other, so that the projections 24 align flush with the recesses in the lateral walls 6 and 7. The sliders 25 are released, so that the force exerted by the spring cause the projections 24 to engage the recesses in the lateral walls 6 and 7.

As especially evident from the depiction on FIG. 3, the frame section 17 accommodates four positioning elements 18. Two positioning elements 18 are each mounted in the section 19 or section 20 of the frame section 17, wherein adjacent positioning elements 18 are tightly packed.

At least sections 19 and 20 of the frame section 17 have the U-shaped cross section illustrated on FIG. 4 to FIG. 9. Therefore, the frame section 17 is formed by two mutually parallel legs 26 and a web 27 that connects the latter. This yields a storage space 29 open relative to the essentially rectangular opening 28 of the frame section 17 or a grooved area with horizontal longitudinal orientation for the respective positioning element 18. The positioning element 18 is designed as a strip, meaning a narrow, oblong component. In the specific exemplary embodiment, the side of the respective positioning element 18 facing the opening 28 has two faces 30 curved away from the opening 28, which face the section 19 or 20 that accommodate the respective positioning element 18. As depicted on FIG. 3, this yields a central area of the opening 28 for accommodating an object with a cylindrical cross section, as well as relative to section 21 or 22 another opening area for accommodating a respective additional object with a circular cross section. In particular, this object involves a beverage cup, a beverage can or a bottle.

FIG. 4 to FIG. 9 illustrate various configurations of the positioning elements 18 for laterally positioning the inserted objects, for example the inserted can, as well as various storage positions for the respective positioning element 18 in the frame section 17. The positioning elements 18 and storage positions illustrated there make it possible to reliably position different kinds of bottles, cups and cans characterized by varying diameters in a structurally simple manner. The respective object is inserted into the receptacle 2 in the direction of the arrow A shown on FIG. 1.

In the embodiment according to FIG. 4, the positioning element 18 is U-shaped, with two mutually parallel legs 31 and a web 32 that connects the latter and has the face 30. The two legs 31 are spaced apart at a relatively small distance, which increases toward the free end of the legs 31. A spring element 33 is active between this area of the positioning element 18 and the web 27 of the frame section 17. It is designed as a leaf spring. The positioning element 18 is guided in the area of its two legs 31 via the legs 26 of the frame section 17. Not shown are means that prevent the positioning element 18 exposed to the action of the spring element 33 from being able to completely move out of the storage space 29 of the frame section 17. The extended end position of the positioning element 18 is illustrated on FIG. 4.

With respect to the additional embodiments according to FIG. 5 to FIG. 9, only the differences relative to the embodiment according to FIG. 4 are highlighted below. For example, instead of a leaf spring, the embodiment according to FIG. 5 is provided with a spring element 33 designed as a helical compression spring. Several such spring elements 33 can indeed interact with the positioning element 18. The positioning element 18 has a flexible design, for example is made out of rubber.

In the embodiment according to FIG. 6, the positioning element 18 can be swiveled downward around the axis 34 mounted in the frame section 17 when an object is introduced from above into the opening 28 of the frame section 17 and comes into contact with the positioning element 18. In particular, this axis 34 uses a wire that also permits the positioning element 18 to limitedly shift in the direction of the web 27.

In the embodiment according to FIG. 7, the positioning element 18 consists of two parts, specifically a bearing section 35 accommodated in the frame section 17, and a positioning section 37 mounted so that it can swivel around an axis 36 therein. The positioning section 37 extends into the opening 28 formed by the frame section 17. As illustrated for the other denoted positions, it can swivel up and down around the axis 36. Both the bearing section 35 and the positioning section 37 can be moved together toward and away from the web 27. The bearing section 35 is here guided between the legs 26 of the frame section 17.

As opposed to the positioning elements 18 or positioning sections 37 that were described in the embodiments covered above and consist of a flexible material, in particular rubber, but can also consist of a non-flexible material, the positioning element 18 according to the embodiment on FIG. 8 is made of a high-quality foamed rubber, which can swivel up and down, as denoted by the two additionally illustrated positions. This foamed rubber with an annular cross section is inserted into the groove formed in the frame section 17 at roughly the area of one third of its rectangular cross section, and rigidly connected, e.g., adhesively bonded, with the frame section 17. At roughly half the cross sectional length, the foamed rubber ring has depressions 38 top and bottom, so that the weakened points there make this positioning element 18 especially flexible to achieve the deformation per the positions additionally shown.

The embodiment according to FIG. 9 involves a high-quality two-component injection molded part formed by the positioning element 18 and frame section 17. While the frame section 17 is relatively stiff, the positioning element 18 consists of a more flexible material. The positioning element 18 has a depression 38 in the transitional area to the frame section 17, so that this embodiment also involves a weakening of the positioning element 18, so that its free end can be advantageously swiveled up and down.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A device for laterally positioning an object in relation to a receptacle arranged in a motor vehicle that partially accommodates the object, comprising:
a frame section; and
a plurality of positioning elements mounted within the frame section,
wherein the frame section is adapted to exhibit grooved areas at least on facing sides to accommodate the plurality of positioning elements in the frame section, as well as the plurality of positioning elements that extend into an opening formed by the frame section.

2. The device of claim 1, wherein the grooved areas have U-shaped cross sections.

3. The device of claim 1, wherein at least one of the plurality of positioning elements is rigidly connected with the frame section.

4. The device of claim 1, wherein the at least one of the plurality of positioning elements is mounted so to move in a direction of the groove areas and oppositely in the frame section.

5. The device of claim 4, wherein the at least one of the plurality of positioning elements is adaptable to move in the direction of the groove areas against a force exerted by a spring.

6. The device of claim 1, wherein the at least one of the plurality of positioning elements has a flexible design.

7. The device of claim 1, wherein the at least one of the plurality of positioning elements has a bearing section mounted in the frame section and a positioning section mounted to swivel therein, which extends into the opening formed by the frame section, and can be swiveled.

8. The device of claim 7, wherein the positioning section is adapted to pivot about a horizontal initial position against a force exerted by a spring, and adapted to move back into the horizontal initial position from a pivoted position in response to a spring force.

9. The device of claim 1, wherein the frame section and the at least one of the plurality of positioning elements are adapted to form a two-component injection molded part.

10. The device of claim 1, wherein the at least one of the plurality of positioning elements is designed as a strip.

11. The device of claim 1, wherein the frame section is rectangular in design, and the plurality of positioning elements are arranged in an area of two longitudinal sides of the frame section.

12. The device of claim 11, wherein the plurality of positioning elements are arranged in the area of each longitudinal side of the frame section.

13. The device of claim 1, wherein a side of the at least one of the plurality of positioning elements facing the opening has at least one face area curved away from the opening.

14. The device of claim 1, wherein the frame section is adapted to detachably connect with lateral walls of the receptacle.

15. The device of claim 1 wherein the receptacle is a separate structural unit with a floor and lateral walls, wherein the receptacle can be placed in a storage space in a console

16. The device of claim 15, wherein the console is a central console of the motor vehicle.
